(19) United States
(12) Patent Application Publication
(10) Pub. No.: US 2022/0051642 A1
(43) Pub. Date: Feb. 17, 2022

(54) BRIGHTNESS RANGE

(71) Applicant: Hewlett-Packard Development Company, L.P., Spring, TX (US)

(72) Inventors: Matthew James Flach, Fort Collins, CO (US); Jonathan Michael Anderson, Fort Collins, CO (US); Mark Allen Lessman, Fort Collins, CO (US)

(73) Assignee: Hewlett-Packard Development Company, L.P., Spring, TX (US)

(21) Appl. No.: 17/415,810

(22) PCT Filed: Apr. 26, 2019
(86) PCT No.: PCT/US2019/029269

§ 371 Date: Jun. 18, 2021

(51) Int. Cl. G09G 5/10; G02B 27/01

(52) U.S. Cl. CPC G09G 5/10; G02B 27/0179; G02B 2027/0187; G09G 2320/0626; G09G 2320/0693; G09G 2320/0261

(57) ABSTRACT

An example display system includes a brightness engine, a pupil engine, and an adjuster engine. The brightness engine identifies a brightness range and the pupil engine identifies a pupil size property. The adjuster engine modifies a display property based on an adjustment to the brightness range based on the pupil size property. In another example, executable instructions cause identification of a brightness level within a range corresponding to a tolerance of pupil constriction and cause adjustment of a display property when the display brightness level is expected to exceed the pupil constriction tolerance. In an example method, a brightness range is identified that corresponds to a maximum constriction and maximum dilation of a pupil, content data that exceeds the brightness range is identified, and a display is caused to present the content data within the brightness range.

### BACKGROUND

Electronic devices interact with displays to provide visual experiences and information. Display technology includes liquid crystal displays (LCDs) and organic light-emitting diode (OLED) displays. Display technology continues to evolve to enhance image quality and include a range of visual properties to enhance the viewing experience.

### BRIEF DESCRIPTION OF THE DRAWINGS

FIGS. 1-3 are block diagrams depicting example display systems.

FIG. 4 depicts example components used to implement example display systems.

FIGS. 5 and 6 are flow diagrams depicting example methods for maintaining display brightness.

### DETAILED DESCRIPTION

In the following description and figures, some example implementations of display systems and/or methods of maintaining display brightness are described. Electronic devices interact with displays to provide visual experiences and information. For example, a virtual reality (VR) system may include a head-mounted display (HMD) that may display immersive visual content. Users may desire to personalize their visual experiences provided by the display. In particular, default brightness levels may be overwhelming for users with sensitive eyes and display settings may need to be manually adjusted accordingly. In an actively changing visual experience, a user may be affected by “snow blindness” or other issues related to visual acuity or visual focus due to a brightness level of a display.

Various examples described below relate to maintaining brightness level of a display to enhance the visual experience for a user, such as optimize visual focus and/or eye comfort as examples. The display systems and display methods discussed herein may adjust a brightness level of a display using pupil information corresponding to a range of brightness suitable to a user. By dynamically changing the brightness level to correspond to a desired pupil size, eye strain may be reduced, and visual focus may be increased, for example.

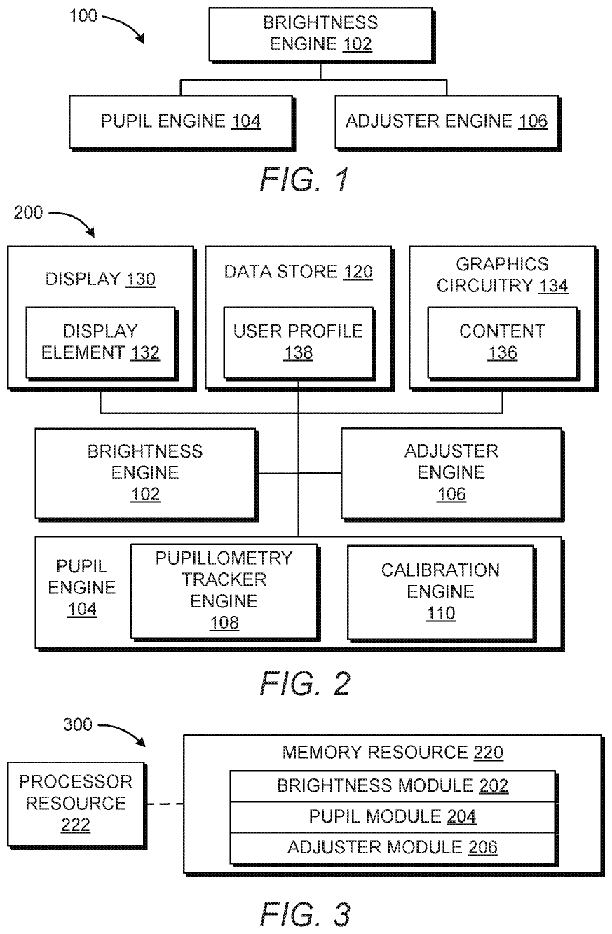

FIGS. 1-3 are block diagrams depicting example display systems 100, 200, and 300. Referring to FIG. 1, the example display system 100 of FIG. 1 generally includes a brightness engine 102, a pupil engine 104, and an adjuster engine 106. In general, the adjuster engine 106 may modify a brightness level of a display by modifying the brightness levels identified by the brightness engine 102 to be within a brightness range determined by the pupil engine 104.

The brightness engine 102 represents any circuitry or combination of circuitry and executable instructions to identify a brightness range of content. For example, the brightness engine 102 may be a combination of circuitry and executable instructions to analyze video data and determine the brightness level of a frame, or multiple frames, of the video data. The brightness engine 102 may include circuitry or a combination of circuitry and executable instructions to perform a comparison between the identified content brightness level and a threshold or other reference. For another example, the brightness engine 102 may determine a brightness range of the content exceeds a threshold reference and cause an indicator, such as an indicator located within the face gasket of an HMD, to activate in response to the content being adjusted to maintain the display property within the identified brightness range.

The pupil engine 104 represents any circuitry or combination of circuitry and executable instructions to identify a pupil size property. For example, the pupil engine 104 may be a combination of circuitry and executable instructions to monitor an attribute of a pupil during changes of brightness of a display and determine a modified bound of the brightness range (identified by the brightness engine 102) based on a degree of changes to the attribute of the pupil. In this manner, the pupil engine 104 may cause a calibration of a minimum pupil size or maximum pupil constriction to use as a reference in determining an appropriate brightness range.

The adjuster engine 106 represents any circuitry or combination of circuitry and executable instructions to modify a display property based on the identified adjustment to the brightness range. For example, the adjuster engine 106 may be a combination of circuitry and executable instructions to use the pupil property identified by the pupil engine 104 to generate a range of brightness for operation of a display and cause an adjustment to the brightness of the display to maintain the displayed content within the generated brightness range. For another example, the adjuster engine 106 may be a controller with a control program that causes the processor of the controller to identify an adjustment to the brightness range based on the pupil size property and modify a display property by modifying a brightness level of a display element. Such examples are discussed in further detail herein.

In some examples, functionalities described herein in relation to any of FIGS. 1-6 may be provided in combination with functionalities described herein in relation to any of FIGS. 1-6.

Referring to FIG. 2, a display system 200 includes components of system 100 and depicts additional elements such as a display 130, a data storage 120, graphics circuitry 134, a pupillometry tracker 108, and a calibration engine 110.

The display 130 is a display device capable of presenting visual content, such as an LCD or OLED display. A display element 132, as used herein, refers to hardware of the display that causes activation of light. For example, the brightness level of a backlight panel of an LCD may be modified by the adjuster engine 106. For another example, the display element may be a thin-film transistor (TFT) backplane that activates or otherwise causes a subpixel of a pixel to emit colored light (e.g., red, green, or blue) at a degree of brightness.

A data store 120 may be a data storage device, such as a memory resource discussed further herein with respect to FIG. 3. A user profile 138 may be stored on the data store 120. The user profile 138 is a data structure containing or otherwise referring to data representing information of a user, such as a pupil size, an eye attribute, a brightness range for an eye or both eyes, etc.

The graphics circuitry 134 may be a graphics card or graphics processing unit (GPU). Content 136 may be video or other image data that is processed by the graphics circuitry 134 for presenting on a screen of the display 130 (e.g., via activating the display element 132).

The pupil engine 104 of FIG. 2 is depicted as containing a pupillometry tracker engine 1078 and a calibration engine 110. In other examples, the logic (e.g., logical division of circuitry and/or executable instructions) of the system 200 may be represented in other ways. The pupillometry tracker engine 108 represents circuitry or a combination of circuitry and executable instructions to perform pupillometry analysis such as measure pupil size of an eye. The calibration engine 110 represents circuitry or a combination of circuitry and executable instructions to perform a calibration operation for an eye to determine an attribute of the eye, such as maximum pupil constriction or minimum pupil size. For example, the calibration engine 110 may be a combination of circuitry and executable instructions to modulate a backlight of a display until the pupillometry tracker engine 108 measures no further contraction of the pupil, update a user profile 138 with a degree of the pupil size property based on pupillometry data observed during the modulation, and set the backlight level of the display element 132 corresponding to the time when no further contraction of the pupil occurs as a threshold reference corresponding to the brightness range.

FIG. 3 depicts the example system 300 may comprise a memory resource 220 operatively coupled to a processor resource 222. Referring to FIG. 3, the memory resource 220 may contain a set of instructions that are executable by the processor resource 222. The set of instructions are operable to cause the processor resource 222 to perform operations of the system 300 when the set of instructions are executed by the processor resource 222. The set of instructions stored on the memory resource 220 may be represented as a brightness module 202, a pupil module 204, and an adjuster module 206. The brightness module 202, the pupil module 204, and the adjuster module 206 represent program instructions that when executed cause function of the brightness engine 102, the pupil engine 104, the adjuster engine 106 of FIG. 1 (or FIG. 2), respectively. The processor resource 222 may carry out a set of instructions to execute the modules 202, 204, 206, and/or any other appropriate operations among and/or associated with the modules of the system 300. For example, the processor resource 222 may carry out a set of instructions to identify a brightness level threshold to maintain a display brightness level within a range corresponding to a tolerance of pupil constriction and cause adjustment of a display property when the display brightness level is expected to cause a degree of constriction outside of bounds of the tolerance of pupil constriction. For another example, the processor resource 222 may carry out a set of instructions to cause a sensor to monitor the pupil size of an eye, calibrate the range of brightness appropriate for an eye of a user by increasing backlight output in a feedback loop until a pupil diameter is sufficiently constant, and store the threshold reference of brightness in a user profile. For yet another example, the processor resource 222 may carry out a set of instructions to generate a brightness range corresponding to a range of dilation of an eye less than maximum dilation of the eye, store a bound corresponding to an identified pupil constriction limit in a user profile to represent the brightness range, and map a level of brightness to display elements located on a screen where displayable content is to be displayed in the brightness range. For yet another example, the processor resource 222 may carry out a set of instructions to analyze event data and color data corresponding to displayable content to be presented on a display and operate the display elements within a determined brightness range based on the mapping of the analyzed event data and analyzed color data to be within the determined brightness range that cause minimum pupil size or maximum constriction during the event corresponding to the event data. In this manner, the control program of the system 300 may be executed to operate the brightness level of the display hardware dynamically with the brightness level of content being displayed in mind to avoid brightness levels that exceed the maximum pupil constrictions threshold.

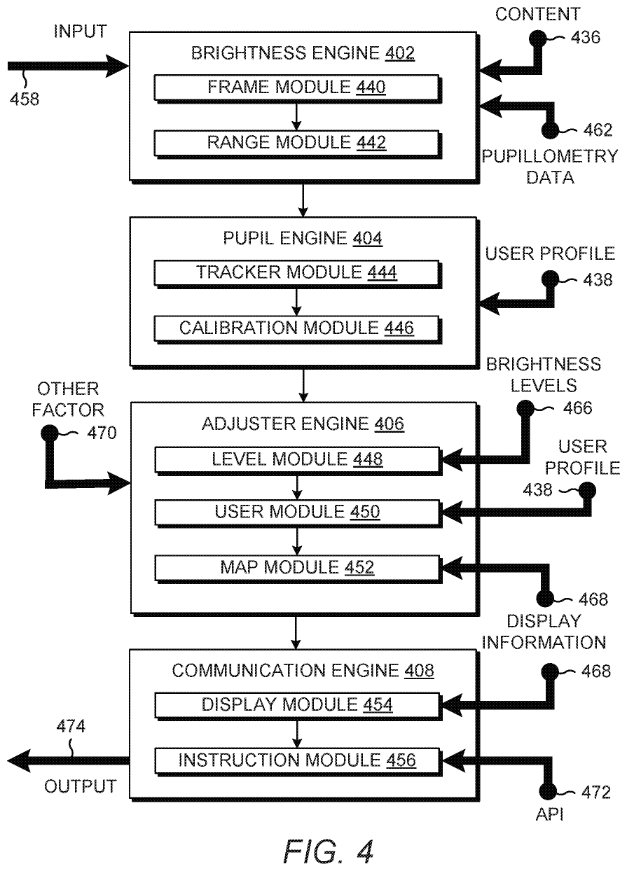

Although these particular modules and various other modules are illustrated and discussed in relation to FIG. 3 and other example implementations, other combinations or sub-combinations of modules may be included within other implementations. Said differently, although the modules illustrated in FIG. 3 and discussed in other example implementations perform specific functionalities in the examples discussed herein, these and other functionalities may be accomplished, implemented, or realized at different modules or at combinations of modules. For example, two or more modules illustrated and/or discussed as separate may be combined into a module that performs the functionalities discussed in relation to the two modules. As another example, functionalities performed at one module as discussed in relation to these examples may be performed at a different module or different modules. FIG. 4 depicts yet another example of how functionality may be organized into modules.

A processor resource is any appropriate circuitry capable of processing (e.g., computing) instructions, such as one or multiple processing elements capable of retrieving instructions from a memory resource and executing those instructions. For example, the processor resource 222 may be a central processing unit (CPU) that enables display by fetching, decoding, and executing modules 202, 204, and 206. Example processor resources include at least one CPU, a semiconductor-based microprocessor, a programmable logic device (PLD), and the like. Example PLDs include an application specific integrated circuit (ASIC), a field-programmable gate array (FPGA), a programmable array logic (PAL), a complex programmable logic device (CPLD), and an erasable programmable logic device (EPLD). A processor resource may include multiple processing elements that are integrated in a single device or distributed across devices. A processor resource may process the instructions serially, concurrently, or in partial concurrence.

A memory resource represents a medium to store data utilized and/or produced by the system 300. The medium is any non-transitory medium or combination of non-transitory media able to electronically store data, such as modules of the system 300 and/or data used by the system 300. For example, the medium may be a storage medium, which is distinct from a transitory transmission medium, such as a signal. The medium may be machine-readable, such as computer-readable. The medium may be an electronic, magnetic, optical, or other physical storage device that is capable of containing (i.e., storing) executable instructions. A memory resource may be said to store program instructions that when executed by a processor resource cause the processor resource to implement functionality of the system 300 of FIG. 3. A memory resource may be integrated in the same device as a processor resource or it may be separate but accessible to that device and the processor resource. A memory resource may be distributed across devices.

In the discussion herein, the engines 102, 104, and 106 of FIGS. 1-2 and the modules 202, 204, and 206 of FIG. 3 have been described as circuitry or a combination of circuitry and executable instructions. Such components may be implemented in a number of fashions. Looking at FIG. 3, the executable instructions may be processor-executable instructions, such as program instructions, stored on the memory resource 220, which is a tangible, non-transitory computer-readable storage medium, and the circuitry may be electronic circuitry, such as processor resource 222, for executing those instructions. The instructions residing on a memory resource may comprise any set of instructions to be executed directly (such as machine code) or indirectly (such as a script) by a processor resource.

In some examples, the system 300 may include the executable instructions may be part of an installation package that when installed may be executed by a processor resource to perform operations of the system 300, such as methods described with regards to FIGS. 4-6. In that example, a memory resource may be a portable medium such as a compact disc, a digital video disc, a flash drive, or memory maintained by a computer device, such as a web server, from which the installation package may be downloaded and installed. In another example, the executable instructions may be part of an application or applications already installed. A memory resource may be a non-volatile memory resource such as read-only memory (ROM), a volatile memory resource such as random-access memory (RAM), a storage device, or a combination thereof. Example forms of a memory resource include static RAM (SRAM), dynamic RAM (DRAM), electrically erasable programmable ROM (EEPROM), flash memory, or the like. A memory resource may include integrated memory such as a hard drive (HD), a solid-state drive (SSD), or an optical drive.

Referring to FIGS. 1-3, the engines 102, 104, 106, 108, and 110 of FIGS. 1-2 and/or the modules 202, 204, and 206 of FIG. 3 may be distributed across devices such as a host, a display, and/or a server device. The engine and/or modules may complete or assist completion of operations performed in describing another engine and/or module. For example, the brightness engine 102 of FIG. 2 may request, complete, or perform the methods or operations described with the brightness engine 102 of FIG. 1 as well as the pupil engine 104 and the adjuster engine 106 of FIG. 1. Thus, although the various engines and modules are shown as separate engines in FIGS. 1-3, in other implementations, the functionality of multiple engines and/or modules may be implemented as a single engine and/or module or divided in a variety of engines and/or modules. In some example, the engines of the system 300 may perform example methods described in connection with FIGS. 4-6.

FIG. 4 depicts example components used to implement example display systems. Referring to FIG. 4, the example components of FIG. 4 generally include a brightness engine 402, a pupil engine 404, an adjuster engine 406, and a communication engine 412. The example components of FIG. 4 may be implemented on a compute device, such as an HMD. A display system, such as display system 100, may receive a request 458 to present content on a display and operates the brightness engine 402, the pupil engine 404, the adjuster engine 406, and the communication engine 412 to generate visuals to display the content within a determined brightness range.

The brightness engine 402 includes program instructions, such as a frame module 440 and a range module 442, to assist determining a brightness range of the content 436 or determining a brightness range of an eye of a user using the pupillometry data 462. The frame module 440 represents program instructions, that when executed cause the brightness engine 402 to analyze a frame of image data to determine a brightness level of a frame of the content 426 and/or a section of the frame. The range module 442 represents program instruction that when executed cause a processor resource to generate a range of brightness corresponding to a portion of image data, such as multiple frames of a video stream, or a range of brightness of an eye, such as a range of brightness between levels of brightness that cause a maximum pupil constriction and a maximum pupil dilation associated with a user 438.

Such pupil information may be determined by a pupil engine, such as pupil engine 404. The pupil engine 404 of FIG. 4 includes a tracker module 444 and a calibration module 446 that represent program instructions to execute functionalities described with respect to the pupillometry tracker engine 108 and the calibration engine 110 of FIG. 2. Such pupillometry information or other information corresponding to the user may be provided by and/or stored in the user profile data structure 438.

The adjuster engine 406 includes modules to assist adjustment of a display to maintain brightness within a range appropriate for a user. The content module 448 represents program instruction that when executed cause a processor resource to obtain brightness levels of the content, such as brightness levels proposed by content to be displayed. The user module 450 represents program instruction that when executed cause a processor resource to obtain user information, such as a pupil property corresponding to a size of the pupil at maximum constriction or a full brightness range useable for the user. The map module 452 represents program instruction that when executed cause a processor resource to map the brightness level 466 to be within the limited brightness range appropriate for the user based on the adjustable attributes of the display, as provided by the display information 468. Such mappings may include shifting the brightness level towards a level of brightness corresponding to a minimum pupil size to improve eye comfort and optimize visual focus, as examples. Other factors 470, such an emotional factor or cognitive load factor corresponding to an event to be displayed, may be used by the adjuster engine 406 to appropriately adjust the levels of brightness. For example, an explosion may be displayed, and the visual experience may be intended to generate a lack of visual focus. This is described in further detail with respect to the method of FIG. 6.

The communication engine 408 represents a combination of circuitry and executable instructions to generate an instruction for a display to cause visual manipulation of the display. For example, the output 474 may be in an instruction to increase or decrease the overall brightness of the display, such as modifying the operation of a backlight of the display. For another example, the output 474 may be an instruction to increase or decrease a section of pixels as managed by a TFT backplane corresponding to a section of the screen to be maintained with a brightness range between maximum and minimum pupil dilation. The display module 454 represents program instructions to identify the area of the display to manipulate and the instruction module 456 represents program instructions to generate an instruction interpretable by the display controller to operate the area of the display within the brightness range, such as via generating a series of instructions calls corresponding to an application programming interface (API) 472 useable with a graphics circuitry of an HMD.

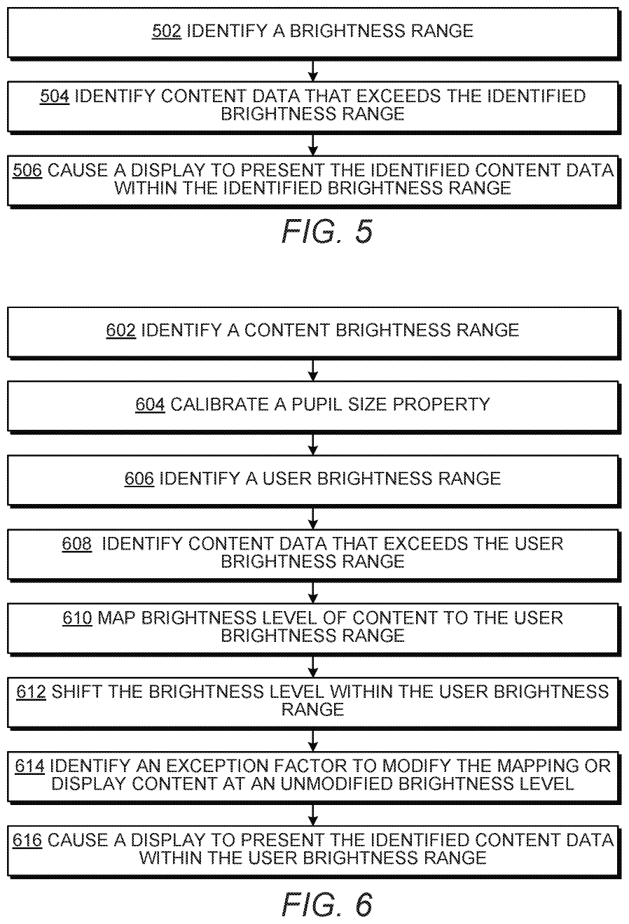

FIGS. 5 and 6 are flow diagrams depicting example methods for maintaining display brightness. Referring to FIG. 5, example methods for display may generally comprise identifying a brightness range corresponding to data representing a maximum constriction of a pupil and a maximum dilation of a pupil, identifying content data that exceeds the identified brightness range, and causing a display to present the identified content data within the identified brightness range. Operations of the methods of FIGS. 5 and 6 are performable by engines 102, 104, 106, 108, and/or 110 of FIGS. 1-3.

At block 502, a brightness range is identified. For example, a range of brightness corresponding to data representing a brightness level for a maximum pupil constriction to a brightness level for a maximum pupil dilation. The brightness range may be for an average eye user or specific to a particular user, such as a user with sensitive eyes or intolerance to eye strain. The brightness range of the user may be identified by a brightness engine and/or pupil engine, such as the brightness engine 102 and pupil engine 104 of FIG. 1.

At block 504, content data is determined to exceed the brightness range identified at block 502. The content data may represent a brightness level recommended for an event of the content to displayed or otherwise associated with a brightness level of a frame, or multiple frames, of image data to be presented on a display. The content brightness levels may be determined by a brightness engine, such as brightness engine 102 of FIG. 1.

At block 506, the content data identified at block 504 is caused to be displayed within the brightness range identified at block 502. For example, a graphics controller may instruct a hardware display element to illuminate to a degree within the brightness range identified at block 502 even though the brightness of the scene of the content data is recommended at a different brightness. In this manner, a user may ensure that content displayed on a display may remain within a particular range of brightness, such as a selected level of brightness or dynamically changed to increase visual focus by modifying brightness to maintain pupil size within a tolerance of maximum pupil constriction. The adjustments to cause the content to be displayed within the brightness range may be performed by an adjuster engine, such as adjuster engine 106 of FIG. 1.

FIG. 6 includes blocks similar to blocks of FIG. 5 and provides additional blocks and details. In particular, FIG. 6 depicts additional blocks and details generally regarding pupil property calibration, brightness level mapping, targeting a specific range of brightness, and operating the display system with a modification factor identified that affects the identified brightness levels. Blocks 606, 608, and 616 are similar to blocks 502, 504, and 506 of FIG. 5 and, for brevity, their respective descriptions are not repeated in their entirety

At block 602, a content brightness range is identified corresponding to content to be displayed. For example, a scene of content may be proposed to be displayed at a number of certain brightness levels, such as indicated by image metadata. The content brightness range may be generated by analyzing an amount of video content data.

At block 604, a pupil size property is calibrated. The calibration routine performed may include modulating an overall brightness level of a display while a monitoring the pupil size of an eye. For example, a sensor, such as a camera, facing towards an eye may monitor the size and/or behavior of the pupil (e.g., capture pupillometry data) during modulation of the brightness level of the display, such as capturing data corresponding to pupil changes observed during increasing the overall brightness level of the display until the pupil size remains sufficiently constant (e.g., the pupil size corresponding to the maximum constriction of the pupil). Calibration data, such as the maximum pupil constriction determined from analysis of pupillometry data observed during the calibration routine, may be stored in a user profile. The user profile can be recalled during operation of the display to reference a pupil size property or for identifying the brightness level of the user. In other example systems, the pupillometry data is constantly monitored and the calibration routines may be performed continually during use of the display.

At block 606, a user brightness range is identified. For example, the pupil size property calibrated at block 604 may have been stored in a user profile and the user brightness range may be retrieved from the user profile and/or calculated from pupil size property data stored in the user profile.

At block 608, content data that exceeds the user brightness range is identified. For example, the content brightness range identified at block 602 is compared to the user brightness range identified at block 606 and if a portion of the content brightness range extends outside the user brightness range, then such content data corresponding to the brightness level outside of the user brightness range is selected or otherwise identified, such as to be mapped to be within the brightness range. In some examples, if any of the content data is beyond the user brightness range, the entirety of the content to be displayed is selected for modification to be within the user brightness range.

At block 610, a brightness level of content is mapped to the user brightness range. For example, all the brightness levels of the content may be mapped to new brightness levels that are within the user brightness range. In that example, the identified user brightness range may be smaller than the content brightness range and/or shifted with respect to the content brightness range. When mapping the brightness level of content to be display from the content brightness range to within the identified user brightness range, the brightest content of the identified content data may be mapped to an upper limit of the user brightness range. For example, the content data may be mapped to be within the user brightness range, but not to a maximum brightness of the user brightness range. At block 612, the identified brightness level of content to be displayed is shifted towards a bound corresponding to the maximum constriction of the pupil (e.g., the brightest level of the user brightness range). By shifting the brightness range being displayed towards the upper bound, the maximum constriction of the pupil may be achieved. Shifting the brightness towards the maximum pupil constriction level may dynamically and continually allow for the user to maintain visual focus and eye comfort, as examples.

At block 614, an exception factor corresponding to content to be displayed is identified. As used herein, an exception factor may be an event, data flag, or data pattern that achieves a classification to generate an exception to the user brightness level, such as an event or video pattern that achieves a threshold set by a user setting, a system setting, or a content setting. For example, the exception factor may be a metadata flag to identify a section of content data as to achieve an emotional, mental, or physical reaction corresponding to a brightness level outside of the user preferred brightness level. In some examples, analysis of the content may identify a section of content to be displayed is to incur undesirable effects of being outside the brightness level of the user, such as a rapid change from dark to light content. In yet other examples, the user preferred brightness range may be further limited by the exception factor, such as to provide safety tolerances to adjust the range by a percentage corresponding to the class of exception factor. In accordance with the identified exception factor, the user brightness range may be modified to a degree corresponding to the categorization of the exception factor, and in this manner, cause a brightness level to a degree beyond the user brightness level for content associated with a specific display event. In some examples, the user brightness range maximum and minimum may be overridden to cause the original or unmodified brightness level of the content may be used to display the content during the display event. This may be useful for certain events that are to cause eye discomfort or decrease visual focus, such as a disorienting game event. At block 616, the display is caused to present the content data within the user brightness range (and/or a modified brightness range for events associated with an emotional factor or cognitive load factor). In this manner, the brightness range displayed on a display, such as an HMD, may be dynamic to the user and the immersive experience to assist in appropriate visual focus and maintain eye comfort as appropriate, as examples.

Although the flow diagrams of FIGS. 4-6 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present description.

All of the features disclosed in this specification (including any accompanying claims, abstract and drawings), and/or all of the elements of any method or process so disclosed, may be combined in any combination, except combinations where at least some of such features and/or elements are mutually exclusive.

The terms “include,” “have,” and variations thereof, as used herein, mean the same as the term “comprise” or appropriate variation thereof. Furthermore, the term “based on,” as used herein, means “based at least in part on.” Thus, a feature that is described as based on some stimulus may be based only on the stimulus or a combination of stimuli including the stimulus. Furthermore, the use of the words “first,” “second,” or related terms in the claims are not used to limit the claim elements to an order or location, but are merely used to distinguish separate claim elements. Further, as used herein, “a” can refer to one such element or more than one such element.

The present description has been shown and described with reference to the foregoing examples. It is understood, however, that other forms, details, and examples may be made without departing from the spirit and scope of the following claims.

What is claimed is:

1. A display system comprising:
a brightness engine to identify a brightness range of content;
a pupil engine to identify a pupil size property; and
an adjuster engine to:
identify an adjustment to the brightness range based on the pupil size property; and
modify a display property based on the identified adjustment to the brightness range.

2. The display system of claim 1, wherein the pupil engine is to:
monitor an attribute of a pupil during changes of brightness of a display; and
determine a modified bound of the brightness range based on a degree of changes to the attribute of the pupil.

3. The display system of claim 1, wherein the adjuster engine is to:
modify the display property by modifying a brightness level of a display element.

4. The display system of claim 1, comprising:
a pupillometry tracker engine to measure pupil size; and
a calibration engine to:
modulate a backlight of a display until the pupillometry tracker engine measures no further contraction of the pupil;
update a user profile with a degree of the pupil size property based on pupillometry data observed during the modulation; and
set the backlight level corresponding to when no further contraction of the pupil occurs as a threshold reference corresponding to the brightness range.

5. The display system of claim 4, wherein:
the brightness engine is to:
determine the brightness range of content exceeds the threshold reference; and
cause an indicator to activate in response to the content being adjusted to maintain the display property within the identified brightness range.

6. A non-transitory computer-readable storage medium comprising a set of instructions executable by a processor resource to:
identify a brightness level threshold to maintain a display brightness level within a range corresponding to a tolerance of pupil constriction; and
cause adjustment of a display property when the display brightness level is expected to cause a degree of constriction outside of bounds of the tolerance of pupil constriction.

7. The medium of claim 6, wherein the set of instructions is executable by the processor resource to:
calibrate the range of brightness of a user; and
store the threshold reference in a user profile.

8. The medium of claim 7, wherein the set of instructions is executable by the processor resource to:
monitor pupil size of an eye; and
increase backlight output in a feedback loop until a pupil diameter is sufficiently constant.

9. The medium of claim 7, wherein the set of instructions is executable by the processor resource to:
generate a brightness range corresponding to a range of dilation of an eye less than maximum dilation of the eye, the brightness range including a bound corresponding to an identified pupil constriction limit; and
map display elements corresponding to displayable content to the brightness range.

10. The medium of claim 9, wherein the set of instructions is executable by the processor resource to:
analyze event data and color data corresponding to the displayable content to be presented on the display; and
operate the display elements within the brightness range based on the mapping of the analyzed event data and analyzed color data to within the brightness range.

11. A method for maintaining display brightness, the method comprising:
identifying a user brightness range corresponding to data representing a maximum constriction of a pupil and a maximum dilation of the pupil;
identifying content data that exceeds the identified user brightness range; and
causing a display to present the identified content data within the identified user brightness range.

12. The method of claim 11, comprising:
mapping brightest content of the identified content data to an upper limit of the brightness range.

13. The method of claim 11, comprising:
modulating an overall brightness level of the display;
monitoring pupil size of an eye of a user during the modulating, the modulating including increasing the overall brightness level of the display until the pupil size remains sufficiently constant; and
storing data corresponding to the monitored pupil size during the modulating in a user profile.

14. The method of claim 11, comprising:
identifying a content brightness range of content to be displayed;
mapping a brightness level of content to be displayed from the content brightness range to within the identified user brightness range, the identified user brightness range being smaller than the content brightness range; and
shifting the brightness level of content to be displayed towards a bound corresponding to the maximum constriction of the pupil.

15. The method of claim 14, comprising:
identifying an exception factor and display event; and
according to the identified exception factor,
modifying the user brightness range, to a degree corresponding to the exception factor, for content associated with the display event, or
displaying content at an original brightness level associated with the display event.
